(19) United States
(12) Patent Application Publication
(10) Pub. No.: US 2010/0109430 A1
(43) Pub. Date: May 6, 2010

(54) MODULAR POWER DISTRIBUTION SYSTEM, METHOD, AND APPARATUS HAVING CONFIGURABLE OUTPUTS

(75) Inventors: Charles T. DiSaverio, Apalachin, NY (US); Timothy Williams, Binghamton, NY (US)

Correspondence Address: MILES & STOCKBRIDGE PC, 1751 PINNACLE DRIVE , SUITE 500, MCLEAN, VA, 22102, US

(73) Assignee: LOCKHEED MARTIN CORPORATION, Bethesda, MD (US)

(21) Appl. No.: 12/266,284

(22) Filed: Nov. 6, 2008

(51) Int. Cl. B60L 1/00; H02J 1/00

(52) U.S. Cl. 307/10.1; 307/31; 307/24

(57) ABSTRACT

A system, method, and apparatus for controlling the supply of power for components of a vehicle. The system comprises a plurality of power modules or apparatuses, a J1939 bus, a plurality of electrical components, and a power supply. Each component is coupled to at least one power module, and the power modules are configured to supply power to electrical components coupled thereto. Each power module includes a controller, a plurality of power output lines, a plurality of pluggable power elements, and a power supply line. The controller is configured to electronically control at least one of the pluggable power elements for each power output line. Thus, the outputs of the power modules are configurable based on controlling the pluggable power elements.

The present invention relates to a system, method, and apparatus for controlling power. In particular, the system, method, and apparatus according to embodiments of the present invention includes configurable outputs for controlling the supply of power for components of a vehicle.

An embodiment of the present invention includes a reconfigurable apparatus. The reconfigurable apparatus comprises power controlling means for controlling power output to outside the reconfigurable apparatus, power supplying means for supplying power to the power controlling means, and controlling means for electronically controlling the power controlling means. The controlling means is coupled to the power controlling means, the controlling means electronically controls the power controlling means based on at least one of signals received from a bus external to the reconfigurable apparatus and signals received from the power controlling means, and the power controlling means is automatically reconfigurable in response to at least one of the signals.

Another embodiment of the present invention includes a method for controlling power to electrical components in a network for a vehicle. The method comprises providing a circuit board coupled to a backplane of a power module, removably coupling a power element to a receptacle of the circuit board, providing a controller adapted to control electronically a supply of power for at least one of the electrical components in the vehicle network, associating the power element with the at least one electrical component of the vehicle network, diagnosing a characteristic associated with the power element, generating a signal in response to the diagnosing, the controller electronically controlling a supply of power for the at least one electrical component by controlling the power element associated with the at least one electrical component based on said generating a signal in response to the diagnosing, and reconfiguring the supply of power in response to the signal.

Another embodiment of the present invention includes a power distribution system for a controller area network (CAN) of a vehicle. The power distribution system can comprise a plurality of power modules having configurable outputs, a J1939 bus, a plurality of electrical components, and a power supply. The J1939 bus is coupled to each of the power modules via an associated node. Each electrical component can be coupled to at least one of the plurality of power modules, and the power supply is coupled to each power module. Each power module is configured to supply power to at least one of the electrical components coupled thereto. Each power module can include a control module, a plurality of power output lines, a plurality of pluggable power elements, and a power supply line. The control module can be coupled to the J1939 bus and configured to receive and transmit signals associated with the J1939 bus. Each power output line is configured to provide power to at least one electrical component of the plurality. A plurality of pluggable power elements can be associated with each of the power output lines, and the power supply line may supply power from the power supply to the plurality of pluggable power elements. The control module is configured to electronically control at least one of the pluggable power elements for each of the power output lines based on signals associated with said J1939 bus. Each power module is configured to provide power load shedding for associated electrical components, and for each power output line, the control module is configured to switch automatically from a malfunctioning pluggable power element to a backup pluggable power element to supply power for the associated power output line.

### BRIEF DESCRIPTION OF THE DRAWINGS

The accompanying drawings illustrate embodiments of the invention. The invention will be best understood by reading the ensuing specification in conjunction with the drawing figures, in which like elements are designated by like reference numerals, and wherein:

FIG. 1 is a block diagram representation of an apparatus or module according to various embodiments of the present invention;

FIG. 2 is a block diagram representation of an apparatus or module according to various embodiments of the present invention;

FIG. 3 is a block diagram representation of a system according to various embodiments of the present invention; and

FIG. 4 is a flow chart representation of a method according to various embodiments of the present invention.

### DETAILED DESCRIPTION

Various embodiments of the present invention are directed generally to a system, method, and apparatus with configurable and/or expandable outputs for controlling the supply of power for components of a vehicle. The system, method, and apparatus are configurable in the sense that

In particular, embodiments of the present invention are directed to a modular controller area network (“CAN”) bus distribution system that can have, for example, a plurality of remote configurable power distribution modules (“CPDM”) or apparatuses used for controlling and monitoring power for a plurality of electronic components. In various embodiments, the system, method, and apparatus include a CAN addressable controller for controlling and monitoring power for a plurality of electrical or electronic components. The CAN network can be the primary means for controlling or configuring the outputs. An external bus, such as a CAN bus, a J1939 bus, etc., may provide the diagnostic and/or prognostic capabilities.

In various embodiments of the present invention, a user, such as an end user, may be able to configure or reconfigure each individual output of the modules by physically removing and/or installing various “pluggable” components. The configuring or reconfiguring also can be done automatically by a processor or controller, for example, wherein the processor or controller controls one or more components associated with a configurable output to control power (or voltage or current) output at the configurable output.

Additionally, the system, method, and apparatus according to various embodiments can allow the end user to completely configure or reconfigure power and/or control needs for the individual outputs at the source (i.e., at the outputs). As an example, the configurable or reconfigurable aspect may refer to using circuit breakers, relays, etc. as a secondary means of controlling power provided to various components or circuits. Moreover, the system, method, and apparatus according to various embodiments may allow on/off control of various common “hotel” loads required for general vehicle operation, for example.

The remote configurable power distribution module CPDM's (or apparatuses) may include, for example, pluggable circuit breakers and/or pluggable relays associated with each of the individual outputs. The circuit breakers may be manually and/or automatic resettable. Moreover, the components can be interchangeable modular components that can be replaced from a common base of components. The system, method, and apparatus, allows for a circuit board to which the components can be removably coupled, to be configured or reconfigured for various roles in a vehicle power system.

Apparatuses according to various embodiments, such as the CPDM's, may be placed or located as dictated by a vehicle or vehicle system in which they are to be implemented. For example, the apparatuses can be located based on a vehicle architecture. Moreover, the apparatuses may be configurable, reconfigurable, and/or expandable based on a particular vehicle or vehicle system. For example, an apparatus according to an embodiment of the present invention can be configured based on the system or network in which the apparatus is to be installed. The apparatus also may be configured, reconfigured, and/or expanded after being installed or placed in a particular system or network, such as a particular vehicle system or network. Additionally, various embodiments allow for on-the-spot configuration using, for example, control relays, by-passing relays, circuit protection, etc. Moreover, the apparatus according to various embodiments can be reconfigured for another system or network, or for different operating conditions or requirements for the initial system or network.

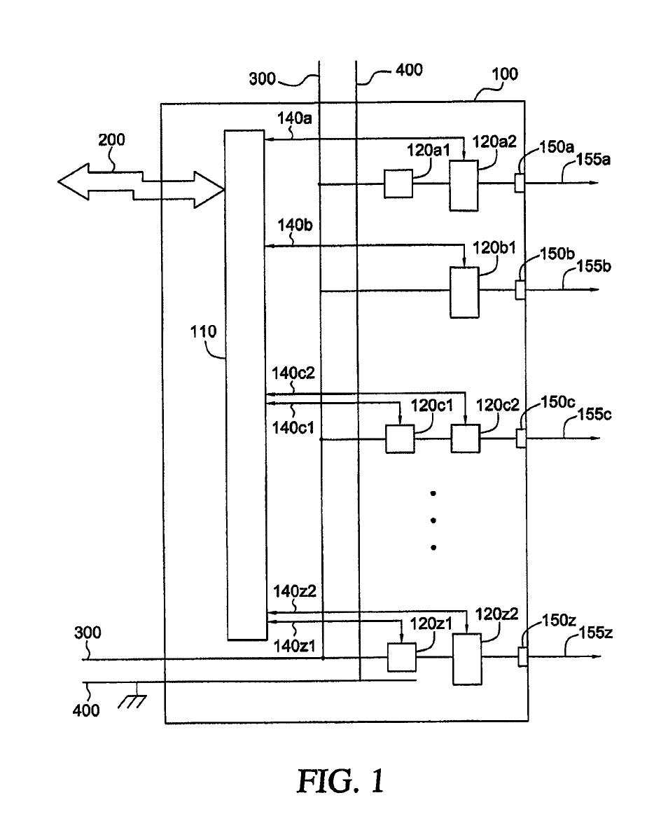

FIG. 1 shows an apparatus (or module) 100 according to various embodiments of the present invention. Apparatus 100 can be of any suitable configuration. In various embodiments, apparatus 100 includes a controller 110, a plurality of components 120, and a plurality of output terminals 150. Apparatus 100 can be configurable, reconfigurable, and/or expandable in the sense that any suitable number of elements 120 can be implemented (added or removed) to configure output terminals 150 of the apparatus 100. Moreover, apparatus 100 can be configurable, reconfigurable, and/or expandable in the sense that controller 110 may control one or more of elements 120 to provide power (or a voltage, a current, or a signal) to at least one electronic or electrical component coupled thereto via one or more corresponding output lines 155. Apparatus 100 is also configurable, reconfigurable, and/or expandable in the sense that load shedding is provided for by the apparatus 100, whereby power output from various outputs of the apparatus 100 is selectively ceased. Configurable, reconfigurable, and/or expandable also includes redundancy or backup functions of the apparatus 100. For example, when a particular power element has malfunctioned or is defective, the apparatus 100 may control a backup power element such that it effectively takes the place of the malfunctioning or defective power element.

Apparatus 100 can also receive and transmit signals via an external bus 200 and receive power from a power supply. The power supply can be of any suitable value and can be alternating current or direct current. For example, the power supply can be 28 vdc, 12 vdc, etc. The power supply can be provided from any suitable source, internal or external to apparatus 100. For example, in FIG. 1, power for apparatus 100 is provided by power supply line 300 and ground line 400. Power supply line 300 and ground line 400 also may be supplied to another apparatus, a component or components, etc. of a system in which the apparatus 100 is associated. In various embodiments, the power supply line 300 and ground line 400 may be provided to another apparatus and components or components via the apparatus 100. Moreover, internal to apparatus 100, the power supply line 300 may be provided to each element 120 (either directly or indirectly) for supplying power thereto. Additionally, power supply line 300 may supply power to each output terminal 150 of apparatus 100 via one or more elements 120.

Controller 110 can be any suitable controller, including, but not limited to, a microcomputer, a microprocessor, a microcontroller, a computing device, a circuit board or boards using electronic components, etc. For example, controller 110 can be a CAN addressable controller. Controller 110 can be configured to operate in accordance with a sequence of programmed instructions and can include a memory in which the programmed instructions are encoded or stored.

Controller 110 can have any suitable coupling or couplings. In various embodiments, controller 110 can be coupled to external bus 200 to receive and transmit signals. The signals may be associated with or specific to the external bus 200. For example, the signals transmitted and received by controller 110 via external bus 200 may be associated with or specific to a CAN bus, a J1939 bus, etc. Controller 110 also may be coupled to some or all of elements 120. In various embodiments, controller 110 may be coupled to some or all of elements 120 via control and/or monitoring lines 140. Controller 110 also may be supplied with a power supply (not shown), which can be either external or internal to the apparatus 100.

Controller 110 can be configured to perform any suitable operation or function. In various embodiments, controller 110 can be configured to electronically or electrically control and/or monitor power for one or more electrical or electronic components coupled to the apparatus 100 (components not shown in this figure). For example, the controller 110 may control elements 120 to control power for associated electrical or electronic components coupled to output terminals 150 via the corresponding output lines 155. Controller 110 also may be configured to monitor characteristics or states of the elements 120 to which it is coupled via control lines 140. In doing so, controller 110 may be able to determine characteristics of the system, of the apparatus 100, or of a component or components. For example, one of the elements 120 may be a circuit breaker and the controller 110 may be coupled thereto. By monitoring the state of the circuit breaker (e.g., open or closed), the controller 110 may be able to determine characteristics of the output line 155 and/or component coupled to the output line 155. For example, when if the controller determines, based on monitoring the circuit breaker, that the circuit breaker has tripped, the controller 110 may determine that there is a short circuit on the associated output line 155 or that the associated component is faulty. By monitoring characteristics or states of the elements 120, controller 110 also may be able to perform diagnostics and/or prognostics.

Controller 110 also may be configured to control at least one element 120 per output terminal 150. In various embodiments, controller 110 can control each element 120 per output terminal 150. Controller 110 may control one or more of the elements 120 based on signals received from external bus 200. The signals may be associated with or specific to the particular external bus implemented. For example, the signals may be associated with or specific to a CAN bus, a J1939 bus, etc. Controller 110 also can control one or more of the elements 120 based on signals or information received from any element or elements 120.

Controller 110 can control one or more other apparatuses 100 via external bus 200. In various embodiments, controller 110 can send control signals that are specific to the external bus 200 to control the one or more other apparatuses 100. For example, controller 110 can send control signals via external bus 200 to control power output of the one or more other apparatuses 100. Moreover, as another example, controller 110 can send control signals via external bus 200 to other apparatuses 100 to configure or reconfigure outputs thereof.

The control signals sent from controller 110 to elements 120 via control lines 140 can be any suitable signals. The signals may be associated with or specific to the system, network, or bus in which the apparatus 100 is implemented. In various embodiments, controller 110 can control each element 120 that it is coupled to automatically and independently of other elements 120 to which it is coupled.

External bus 200 can be any suitable bus and can facilitate reception and transmission of any suitable signals. In various embodiments, external bus 200 can be specific to a bus for vehicles. For example, external bus 200 may be a CAN bus, a J1939 bus, etc. External bus 200 can be coupled to a plurality of apparatuses 100 via a main bus 250 (not shown in FIG. 1).

As can be seen from FIG. 1, apparatus 100 includes a plurality of elements 120. Apparatus 100 can have any suitable number of elements, the elements 120 can be of any suitable configuration, and the elements 120 can have any suitable operation and/or function. Moreover, the elements 120 can be the same or different. In various embodiments, at least one element 120 of the plurality can be associated with each output terminal 150 and output line 155. As an example, each output terminal 150 and associated output line 155 can have associated therewith a plurality of elements 120. However, some or all of the output terminals 150 and associated output lines 155 can have only one element 120 associated therewith. In one embodiment, elements 120 associated with a same one of the output terminals 150 may be different elements having different functions and/or operations. In another embodiment, elements 120 associated with a same one of the output terminal 150 can be substantially the same element, having substantially the same function and/or operation. Embodiments of the present invention also envision apparatus 100 having a combination of different elements having different functions for a same output terminal 150 and same elements having same functions for anther same output terminal 150.

Each element 120 may be pluggable or replaceable. For example, each element 120 can be physically replaced with another element 120 of the same type of element 120. The same type of element includes having the same physical characteristics, the same operation, and/or the same function. Each element 120 can also be replaced with an element 120 having a different physical characteristic, a different operation, and/or a different function. Additionally, each element 120 can be plugged into or removably affixed to a circuit board which coupled to a backplane of any suitable configuration. For example, the backplane can be a block backplane with a fixed mechanical format that allows the same backplane to be configured for various roles in a vehicle power system. In various embodiments, each element 120 can be plugged into one of a plurality of receptacles of a circuit board, such as the backplane.

The receptacles can be any suitable receptacle including a socket. In various embodiments, each type of element (e.g., function, operation, or configuration) may be configured to be plugged into or affixed to any of the receptacles, thereby making all of the elements 120 interchangeable from receptacle to receptacle. Alternatively, the receptacles may be configured to prevent certain types of elements 120 (e.g., with certain functions, operations, or configurations) from being plugged into the receptacle.

Any suitable number of elements 120 can be controlled by controller 110, for example. In various embodiments, the elements 120 can be controlled based on signals received from the external bus 200, a characteristic or condition of the associated output terminal 150 or output line 155, a characteristic or condition of another element 120, and/or a characteristic or condition of another output terminal 150 or output line 155. For example, controller 110 may detect a condition of element 120a2 associated with the output terminal 150a via control line 140a and control one or more of the elements 120 (e.g., 120b1, 120c1, 120c2, . . . 120z1, 120z2, etc.) associated with another of the output terminals 150 (b-z) to control power to corresponding output terminals 150 (b-z).

In various embodiments, some or all of elements 120 can be power elements. For example, each element 120 may be one of a fuse, a circuit breaker, a pass through element, a normally open element, a normally closed element, a step down converter, and a step up converter. Note, however, that the elements 120 are not limited to the foregoing examples and can be any suitable element for outputting, modifying, and/or controlling power, voltage, or current to output terminals 150. In various embodiments, each element 120 may be configured to control power output to outside the apparatus 100. For example, each element 120 may be configured to control power to a component coupled to the apparatus 100 via output line 155.

Apparatus 100 can have any suitable number of output terminals 150 of any suitable configuration. In various embodiments, output terminals 150 may be coupled to respective output lines 155, each of which may be coupled to one or more electrical or electronic components. Each output terminal 150 may be coupled to one or more of elements 120 for supply of power via the one or more elements 120 to outside apparatus 100. In various embodiments, power outputted from output terminal 150 can be supplied to one or more electrical or electronic components. In various embodiments, the one or more electrical or electronic components can be vehicle components.

Apparatus 100 may be configured, reconfigured, and/or expanded manually and/or electronically. In various embodiments, controller 110 can control some or all of elements 120 to configure or reconfigure associated output terminal 150 of apparatus 100. Additionally, any suitable combination of elements 120 of various functions and/or operations can be plugged into apparatus 100 to configure or reconfigure the associated output terminals 150. In various embodiments, some of the elements 120 may be manually controlled, thereby allowing manual configuring or reconfiguring of the outputs of the apparatus 100. For example, if an element 120 takes the form of a circuit breaker, the circuit breaker can be reset manually and/or electronically, thereby reconfiguring the output at the associated output terminal 150. In various embodiments, the circuit breaker can be reset in response to signals from the external bus 200. The circuit breaker element 120 can be controlled such that when the circuit breaker element is open, no power can be provided to the corresponding output terminal 150, and when the circuit breaker is reset, either manually or electronically, power can be provided to the corresponding output terminal 150.

As an example of a configuration of elements 120 associated with one of the output terminals 150 for apparatus 100 in FIG. 1, the elements 120a includes two elements 120a1 and 120a2 associated with output terminal 150a and corresponding output line 155a. Controller 110 can be coupled to element 120a2 to provide electrical or electronic control and monitoring of the element 120a2. In this example, element 120a1 may be a fuse or circuit breaker, and element 120a2 may be a normally open element, such as, but not limited to, a normally open relay. Note, however, that any suitable element or elements 120 can be associated with each output terminal 150. Additionally, controller 110 can be coupled to control any suitable number of elements associated with each output terminal 150. In this example, power line 300 may be coupled to output terminal 150a via the fuse element 120a1 and the normally open element 120a2. In operation, controller 110 can control element 120a2 to control power from power line 300 to the output terminal 150a, and to one or more electrical or electronic components coupled thereto via output line 155a. In various embodiments, controller 110 can control element 120a2 via control line 140a. For example, if the element 120a2 of associated with output terminal 150a is a normally open element, controller 110 can send a signal or signals via control line 140a to close the normally open element 120a2 or to “re-open” a closed normally open element, thereby controlling whether power from power line 300 is output to the output terminal 150a.

In various embodiments, apparatus 100 may have a redundancy feature built therein. For example, two or more output lines 155 may be coupled to the same component or components 160. Controller 110 can control elements 120 for each output terminal 150 such that one output terminal 150 provides power to the component or components 160 via the associated output line 155, while the other of the output terminal or terminals 150 are controlled (associated elements 120 are controlled) such that power is not supplied to the associated output terminal or terminals 150. Should a fault or problem develop in any of the power-supplying element or elements 120, output terminal 150, or associated lines or circuitry, the controller 110 can control the power-supplying element or elements 120 such that at least one of the elements 120 now prevents or reduces power supplied to the corresponding output terminal 150, and the controller 110 can control one or more elements 120 not associated with the fault-related output terminal 150 to now provide power to their corresponding output terminal 150 to thereby continue the supply of power to the one or more components coupled to the output line 155. In various embodiments, the control may be substantially simultaneous to maintain a substantially uninterrupted supply of power to the component or components. The redundancy feature of apparatus 100 also includes providing a backup element 120 for when a particular element 120 has malfunctioned or is defective. For example, the apparatus 100 may control a backup element 120 associated with a same power output line 150 as a defective or malfunctioning element 120 such that the backup element 120 effectively takes the place of the malfunctioning or defective power element 120.

In various embodiments, apparatus 100 may be configured to diagnose a characteristic or condition of components 160 and/or output lines 160 associated therewith. Apparatus 100 also may be able to diagnose a characteristic or condition of the elements 120. In various embodiments, the diagnosing may be based on the controlling of elements 120. The diagnosing also may be based on monitoring and detecting a characteristic, a condition, or information related to one or more of elements 120 and/or of one or more of components 160 coupled to the elements 120 via output terminals 150 and corresponding output lines 155. In various embodiments, the characteristic can be associated with element 120. The characteristic also can be associated with one or more of the electrical components 160 or associated output terminal 150 or output line 155. For example, a characteristic, a condition, or information detected or monitored may indicate an open, a short, and a tripped circuit breaker for an associated output line 155.

In various embodiments, apparatus 100 may be configured to provide prognosticating operations or functions for elements 120 and/or for components 160 coupled thereto via output terminals 150 and output lines 155. In various embodiments, the prognosticating may be performed by controller 110 and based on the controlling of elements 120. The prognosticating also may include monitoring elements 120 and estimating, based on signals received from the monitored element 120, a condition or a soon-to-be condition of the monitored element 120 and/or the associated component 160 coupled thereto. The prognostics also may be based on information associated with one or more of the elements 120. In various embodiments, the prognostics may include detecting and/or recording information from elements 120. The information may be stored in any suitable storage means, such as, but not limited to, RAM, SRAM, DRAM, ROM, EEPROM, etc. The information detected may provide an indication of when a component 160 or element 120 may go bad or fail. For example, the information may be related to a number of times a certain element 120 has actuated, or for how long the element 120 has been providing power to a component 160 via output terminal 150 (e.g., how long a component has been energized). Based on this information, the controller 110 may be able to determine how long the load or component 160 has been on and estimate (or prognosticate) the remaining life cycle of that component 160. The controller 110 also could prognosticate the remaining life cycle of a particular element 120 based on the number of times the element has been activated or energized, for example.

Embodiments of the apparatus 100 shown in FIG. 1 can also include a reconfiguring function or operation including a load shedding function or operation. For the load shedding with respect to components 160 associated with a particular apparatus 100, the load shedding may include monitoring power or electric usage by the components 160 and shutting down/stopping or reducing power to various ones of the components 160. In various embodiments, controller 110 can monitor the power or electric usage of components 160 coupled thereto via output lines 155, and control corresponding elements 120 to cease or limit power to various ones of the components 160. A command to perform load shedding for components 160 coupled to an apparatus 100 may also come from outside the apparatus 100, such as via external bus 200 and main bus 250 (e.g., CAN bus or J1939 bus). In various embodiments, the monitoring of the power or electric usage may be continous. Moreover, the shutting down or controlling one or more elements 120 to cease or lower power provided to one or more of the components 160 may be based on an upper load threshold of electric or power use by the component or components 160. Furthermore, in various embodiments, the load shedding may be performed in a predetermined order.

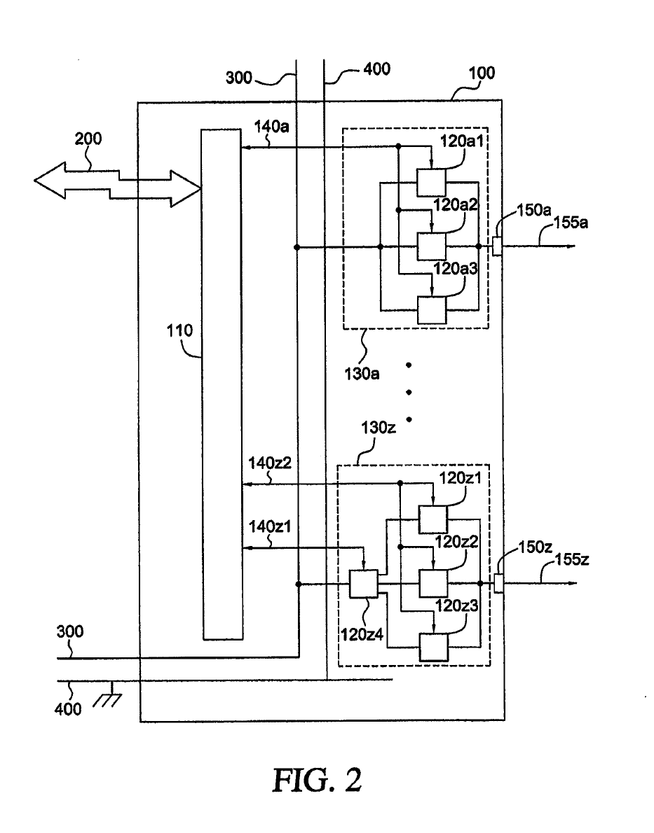

FIG. 2 shows an apparatus (or module) 100 according to various embodiments of the present invention. The apparatus 100 is substantially the same as the apparatus 100 shown in FIG. 1, except that the apparatus 100 in FIG. 2 has a plurality of elements 130 each having a plurality of elements 120 (or element portions). Apparatus 100 can have any suitable number of elements 130, and elements 130 can have any suitable number of element portions 120. In various embodiments, both element 130 and element portions 120 can be pluggable power elements, and element portions 120 can be substantially as described above for elements 120. Moreover, none, some, or all of elements 130 may have the same configuration. Note that in FIG. 2, for example, neither of the shown elements 130a and 130z have the same configuration in the sense of number of element portions 120.

Each element 130 may be associated with at least one output terminal 150 and associated output line 155. Moreover, each element 130 can be coupled to power line 300 and to controller 110 via one or more control lines 140. In various embodiments, controller 110 can be configured to control each of the elements 130 to control power supplied to associated output terminals 150. Elements 130 may be controlled based on one or more signals received from the external bus 200, a characteristic or condition of the associated output terminal 150 or output line 155, a characteristic or condition of another element 120, and/or a characteristic or condition of another output terminal 150 or line 155. For example, controller 110 may detect a condition of element 130a associated with output terminal 150a and control element 130z, for example, to provide power to the corresponding output terminal 150z. Output terminals 150 may be coupled to one or more components and can supply power to the components based on controlling of the associated element 130.

As noted above, elements 130 can have any suitable number of element portions 120, and element portions 120 can be any suitable elements. In various embodiments, some or all of element portions 120 can be power elements. For example, each element portion 120 may be one of a fuse, a circuit breaker, a pass through element, a normally open element, a normally closed element, a step down converter, and a step up converter. Note, however, that the element portions 120 are not limited to the foregoing examples and can be any suitable element for outputting, modifying, or controlling a power, voltage, or current to components coupled to output terminals 150 and output lines 155. For example, element portion 120z4 may be a switching element that supplies power to only one of the element portions 120z1, 120z2, and 120z3 at a time.

Some of all of elements 130 can be controlled. In various embodiments, controller 110 can control some of all of the elements 130. Moreover, some or all of the element portions 120 can be controlled or monitored by controller 110, for example. In various embodiments, controller 110 can control and/or monitor element portions 120 to configure or reconfigure the outputs at the output terminals 150 of the apparatus 100. Furthermore, the control and/or monitoring can be substantially the same as described above for FIG. 1.

As with FIG. 1, the apparatus 100 of FIG. 2 may include a redundancy or back-up power feature by having components 160 coupled to more than one output line 155, for example. For example, two or more output lines 155 may be coupled to the same component or components 160. Controller 110 can control element portions 120 for each output terminal 150 such that one output terminal 150 provides power to the component or components 160 via the associated output line 155, while the other of the output terminal or terminals 150 are controlled (associated element portions 120 are controlled) such that power is not supplied to the associated output terminal or terminals 150. Should a fault or problem develop in any of the power-supplying element portion or portions 120, output terminal 150, or associated lines or circuitry, the controller 110 can control the power-supplying element portion or portions 120 such that at least one of the element portions 120 now prevents or reduces power supplied to the corresponding output terminal 150, and the controller 110 can control one or more element portions 120 not associated with the fault-related output terminal 150 to now provide power to their corresponding output terminal 150 to thereby continue the supply of power to the one or more components coupled to the output line 155. In various embodiments, the control may be substantially simultaneous to maintain a substantially uninterrupted supply of power to the component or components.

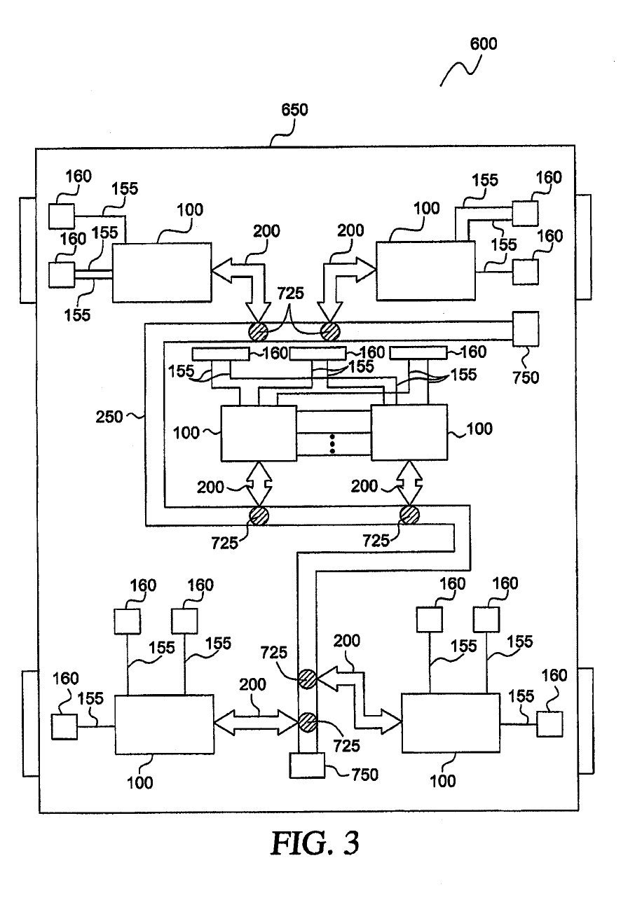

The apparatus 100 of FIG. 2 also may be configured to diagnose a characteristic or condition of components 160 and/or output lines 155 associated therewith (components 160 shown in FIG. 3). In various embodiments, the diagnosing may be based on controlling of element portions 120 of elements 130. The diagnosing also may be based on monitoring and detecting a characteristic, a condition, or information related to one or more of element portions 120 and/or of one or more of components 160 coupled to the elements 130 via output terminals 150 and corresponding output lines 155. In various embodiments, the characteristic, condition, or information can be associated with element portion 120. The characteristic, condition, or information also can be associated with one or more of the electrical components 160 or associated output terminal 150 and output line 155. For example, a characteristic, a condition, or information detected or monitored may indicate an open, a short, and a tripped circuit breaker for an associated output line 155.

The apparatus 100 of FIG. 2 further may be configured to provide prognosticating operations or functions for elements 130, element portions 120, and/or one or more components 160 coupled thereto via output terminals 150 and output lines 155 (components 160 shown in FIG. 3). In various embodiments, the prognosticating may be performed by controller 110 and based on the controlling of elements 130 and/or element portions 120. The prognosticating also may include monitoring element portions 120 and estimating, based on signals received from the monitored element portion 120, a condition or a soon-to-be condition of the monitored element portion 120, associated element 130, and/or the associated component 160 coupled thereto. The prognostics also may be based on information associated with one or more of the element portions 120. In various embodiments, the prognostics may include detecting and/or recording information from elements 130 and/or element portions 120. The information may be stored in any suitable storage means, such as, but not limited to, RAM, SRAM, DRAM, ROM, EEPROM, etc. The information detected may provide an indication of when a component 160, element 130, or element portion 120 may go bad or fail. For example, the information may be related to a number of times a certain element portion 120 has actuated, or for how long the element 130 or element portion 120 has been providing power to a component 160 via output terminal 150 (e.g., how long a component has been energized). Based on this information, the controller 110 may be able to determine how long the load or component 160 has been on and estimate (or prognosticate) the remaining life cycle of that component 160. The controller 110 also could prognosticate the remaining life cycle of a particular element 130 or element portion 130 based on the number of times the element portion 130 has been activated or energized, for example.

The apparatus 100 shown in FIG. 2 can include a load shedding function or operation. For the load shedding with respect to components 160 associated with a particular apparatus 100, the load shedding may include monitoring power or electric usage by the components 160 and shutting down/stopping or reducing power to various ones of the components 160 (components 160 shown in FIG. 3). In various embodiments, controller 110 can monitor the power or electric usage of components 160 coupled thereto via output lines 155, and control corresponding elements 130 to cease or limit power to various ones of the components 160. A command to perform load shedding for components 160 coupled to an apparatus 100 may also come from outside the apparatus 100, such as via external bus 200 and main bus 250 (e.g., CAN bus or J1939 bus). In various embodiments, the monitoring of the power or electric usage may be continous. Moreover, the shutting down or controlling one or more elements 130 to cease or lower power provided to one or more of the components 160 may be based on an upper load threshold of electric or power use by the component or components 160. Furthermore, in various embodiments, the load shedding may be performed in a predetermined order.

FIG. 3 shows a system 600 according to various embodiments of the present invention. System 600 can be implemented in any suitable means. In various embodiments, system 600 may be implemented in a vehicle 650. Vehicle 650 can be any suitable vehicle of any suitable configuration. For example, vehicle 650 can be a car, a truck, a trailer, an all terrain vehicle, a military vehicle, etc. Vehicle 650 can have any suitable conveying means, such as, but not limited to, wheels, treads, etc. For example, FIG. 3 shows vehicle 650 having four wheels. Note, however, that vehicle 650 is not limited to having four wheels, and may have any suitable number of wheels. Vehicle 650 can have any suitable motive means, such as, but not limited to, an engine, a motor, etc. Vehicle 650 also could be mechanically coupled to another vehicle which provides the means by which vehicle 650 is moved. For example, vehicle 650 may be a trailer that is “pulled” by a wheeled truck or all terrain vehicle.

System 600 can have any suitable configuration. In various embodiments, system 600 can have a plurality of components 160, a plurality of apparatuses (or modules) 100, and a main bus 250.

Main bus 250 can be any suitable bus of any suitable configuration. In various embodiments, main bus 250 can be associated with or specific to a bus for vehicles. For example, main bus 250 can be a CAN bus, a J1939 bus, etc. Main bus 250 may include terminators 750 at each ends thereof. Moreover, main bus 250 can be coupled to modules or apparatuses 100 via respective nodes 725.

System 600 can have any suitable number of apparatuses 100. Apparatuses 100 can be coupled to one or more components 160 via output lines 155. In various embodiments, apparatuses 100 can be coupled to components 160 via two or more output lines 155. Moreover, apparatuses 100 can be coupled to other apparatuses 100 via one or more output lines 155. Apparatuses 100 for system 600 can be of any suitable configuration and can perform any suitable function or operation. In various embodiments, apparatuses 100 can be configured substantially as described above for FIG. 1 and FIG. 2.

Components 160 can be any suitable component. In various embodiments, components 160 can be electrical or electronic components. For example, components can be common “hotel” loads for general vehicle operation. Components 160 can be coupled to one or more apparatuses 100 via one or more output lines 155. In various embodiments, components 160 may receive power (or voltage, current, or a signal) from one or more of the apparatuses 100.

In various embodiments, system 600 can be configured to provide a redundancy or back-up power feature for components 160 and/or apparatuses 100. For example, if one of the apparatuses 100 fails, another apparatus 100 may be controlled (e.g., configured, reconfigured, or expanded as described above) to provide power to commonly connected components 160. As another example, should an internal or external power supply fail for one of the apparatuses 100, another of the apparatuses 100 can be controlled (e.g., configured, reconfigured, or expanded as described above) to provide power to the apparatus 100 whose power supply has failed.

In various embodiments, system 600 also may be configured to provide prognosticating operations or functions for elements 120 and/or for components 160 coupled thereto via output terminals 150 and output lines 155. In various embodiments, the prognosticating may be performed by one or more of the controllers 110 of the apparatuses 100 based on the controlling of elements 120. The prognosticating also may include monitoring elements 120 and estimating, based on signals received from the monitored element 120, a condition or a soon-to-be condition of the monitored element 120 and/or the associated component 160 coupled thereto. The prognostics also may be based on information associated with one or more of the elements 120. In various embodiments, the prognostics may include detecting and/or recording information from elements 120. The information may be stored in any suitable storage means, such as, but not limited to, RAM, SRAM, DRAM, ROM, EEPROM, etc. The information detected may provide an indication of when a component 160 or element 120 may go bad or fail. For example, the information may be related to a number of times a certain element 120 has actuated, or for how long the element 120 has been providing power to a component 160 via output terminal 150 (e.g., how long a component has been energized). Based on this information, the controller 110 may be able to determine how long the load or component 160 has been on and estimate (or prognosticate) the remaining life cycle of that component 160. The controller 110 also could prognosticate the remaining life cycle of a particular element 120 based on the number of times the element has been activated or energized, for example.

In addition to providing load shedding for components as discussed above, system 600 also may provide for a reconfiguring operation or function including load shedding with respect to the apparatuses 100 themselves. In various embodiments, the load shedding operations and/or functions with respect to apparatuses 100 may include monitoring power or electric usage by the apparatuses 100 and shutting down or stopping power to various ones of the apparatuses 100. A command to perform load shedding for apparatuses 100 can be generated by any suitable source. In various embodiments, the command may be generated by one of the apparatuses 100 designated as the “master” apparatus. In various embodiments, the command may be transmitted by the main bus 250 and external buses 200. Moreover, the shutting down or ceasing or lower power to one or more of the apparatuses 100 may be based on an upper load threshold of electric or power use by the apparatus or apparatuses 100. Furthermore, in various embodiments, the load shedding may be performed in a predetermined order.

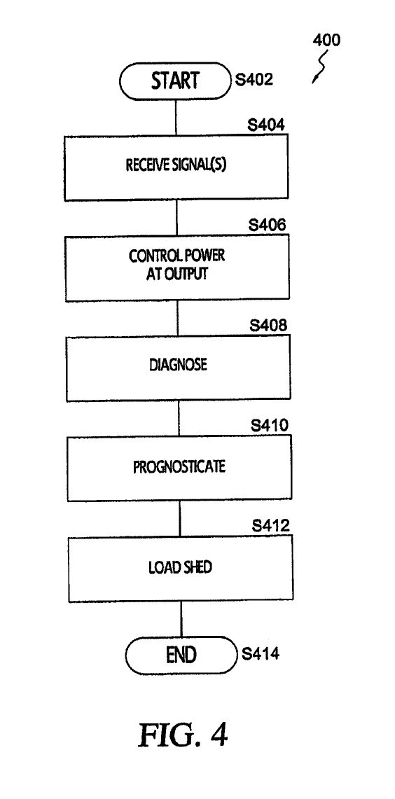

FIG. 4 shows a method 400 according to various embodiments of the present invention. Method can be any suitable method. In various embodiments, method 400 can be for controlling and/or monitoring power to components in a network. Moreover, in various embodiments, method 400 can be for configuring or reconfiguring outputs of modules or apparatuses 100. The network may be associated with a vehicle, for example. In various embodiments, the network may be a controller area network.

In various embodiments, the method 400 may start at S402 and proceed to any suitable step or operation. In various embodiments, the method may proceed to S404.

S404 can be any suitable step or operation. In various embodiments, S404 may include receiving a signal associated with one of the electrical components 160. For example, controller 110 of apparatus 100 may receive one or more of a signal from external bus 200 and a signal from one or more elements 120. The signal thus received may be to control one or more of elements 120 or may be information associated with or from one or more of the elements 120. In various embodiments, the signal from external bus 200 may be associated with the specific bus or a network, such as, but not limited to, a CAN bus, a J1939 bus, etc. The method may then proceed to any suitable step or operation. In various embodiments, the method may proceed to S406.

S406 can be any suitable step or operation. In various embodiments, S406 can include controlling a supply of power (or voltage, current, or a signal). In various embodiments, S406 can include controlling a supply of power to output terminal 150. For example, controller 110 of apparatus 100 may automatically and electronically control various ones of elements 120 to output, control, or modify the power output to a corresponding output terminal 150. In various embodiments, the power for one or more electrical components 160 can be controlled by controlling one or more of the elements 120 associated with the corresponding output terminal 150 and output line 155. Moreover, the controller 110 can control the elements 120 based on signals received in S404. The method may then proceed to any suitable step or operation. In various embodiments, the method may proceed to S408.

S408 can be any suitable step or operation. In various embodiments, S408 can include diagnosing a characteristic or condition of the network, of one or more apparatuses 100 or elements 120 thereof, and/or of one or more components 160. The diagnosing can be based on the controlling step or operation S406 discussed above. Additionally, S408 can include monitoring and/or detecting a characteristic, a condition, or information of one or more apparatuses 100 or elements 120 thereof, and/or of one or more components 160. The diagnosing can be based on the detection of a characteristic, a condition, or information. In various embodiments, the characteristic, condition, or information can be associated with either element 120 or element 130. The characteristic, condition, or information also can be associated with one or more of the electrical components 160 or associated output terminal 150 or output line 155. For example, a characteristic, a condition, or information detected for the diagnosing step may indicate an open, a short, or a tripped circuit breaker for an associated output line 155. The method may then proceed to any suitable step or operation. In various embodiments, the method may proceed to S410.

S410 can be any suitable step or operation. In various embodiments, S410 can include prognosticating a characteristic or condition of the network, of one or more apparatuses 100 or elements 120 thereof, and/or of one or more components 160. The prognosticating my be performed by controller 110 for an associated apparatus 100 or associated output lines 155 and respective components 160. In various embodiments, the prognosticating can be performed based on controlling power at output terminals 150, such as in S406. Additionally, the prognosticating may include monitoring at least one of the elements 120, 130, and estimating, based on the monitored element 120, 130, a condition of the monitored element 120, 130 and/or a component 160 coupled thereto via output terminal 150 and output line 150. The prognosticating may be based on information associated with one or more of the elements 120, 130. For example, the prognostics may be able to detect and record information from elements 120, 130 that may provide an indication of when a component 160 or element 120, 130 may go bad or fail. For example, the information may be related to a number of times a certain element 120 has actuated, for example, or for how long the element 120, 130 has been providing power to a component 160 via output terminal 150 (e.g., how long a component has been energized). Based on this information, the method may be able to determine how long the load or component 160 has been on and estimate (or prognosticate) the remaining life cycle of a particular component 160. In various embodiments, the prognosticating could include prognosticating the remaining life cycle of a particular element 150 based on the number of times the element has been activated or energized, for example. The method may then proceed to any suitable step or operation. In various embodiments, the method may proceed to S412.

At S412, the method may perform a load shedding operation or function. The load shedding operation may be with respect to components 160 coupled to apparatuses 100 and/or with respect to apparatuses 100 themselves.

For load shedding with respect to the apparatuses 100 themselves, load shedding may include monitoring power or electric usage by the apparatuses 100 and shutting down or stopping power to various ones of the apparatuses 100. A command to perform load shedding for apparatuses can be generated by any suitable source. In various embodiments, the command may be generated by one of the apparatuses 100 designated as the “master” apparatus. Moreover, the shutting down or ceasing or lowering power to one or more of the apparatuses 100 may be based on an upper load threshold of electric or power use by the apparatus or apparatuses 100. Furthermore, in various embodiments, the load shedding may be performed in a predetermined order.

For the load shedding with respect to components 160 associated with a particular apparatus 100, load shedding may include monitoring power or electric usage by the components 160 and shutting down or stopping power to various ones of the components 160. In various embodiments, controller 110 can monitor the power or electric usage of components 160 coupled thereto via output lines 155 and control corresponding elements 120 to cease or limit power to various ones of the components 160. A command to perform load shedding for components 160 coupled to an apparatus 100 may also come from outside the apparatus, such as via external bus 200 and main bus 250. Moreover, the shutting down or controlling one or more elements 120 to cease or lower power provided to one or more of the components 160 may be based on an upper load threshold of electric or power use by the component or components 160. Furthermore, in various embodiments, the load shedding may be performed in a predetermined order. The method may then proceed to any suitable step or operation. In various embodiments, the method may proceed to S414, where the method ends.

While FIG. 4 shows a diagnose step at S408, a prognosticate step at S410, and a load shedding step at S412, the order in which these steps can be performed is not limited to the foregoing, and the steps can be performed in any suitable order. Moreover, though not shown, the diagnose step, the prognosticate step, and the load shedding step can be performed substantially simultaneously. Additionally, not all of the steps are required to be performed. For example, various embodiments may include none of, one of, or two of the diagnose, prognosticate, and load shedding steps.

While the present invention has been described in conjunction with a number of embodiments, the invention is not to be limited to the description of the embodiments contained herein, but rather is defined by the claims appended hereto and their equivalents. It is further evident that many alternatives, modifications, and variations would be or are apparent to those of ordinary skill in the applicable arts. Accordingly, all such alternatives, modifications, equivalents, and variations that are within the spirit and scope of this invention.

What is claimed is:

1. A power distribution system for a controller area network (CAN) of a vehicle comprising:
a plurality of power modules having configurable outputs;
a J1939 bus, the J1939 bus being coupled to each said power module via an associated node;
a plurality of electrical components, each said electrical component being coupled to a power module of said plurality; and
a power supply to provide power to each said power module,
wherein each said power module is configured to supply power to associated ones of said electrical components coupled thereto,
wherein each said power module includes:
a control module coupled to said J1939 bus and configured to receive and transmit signals associated with said J1939 bus;
a plurality of power output lines, each said power output line being configured to provide power to one said electrical component coupled thereto;
a plurality of pluggable power elements, a plurality of said pluggable power elements being associated with each of said power output lines, and
a power supply line to supply power from said power supply to said plurality of pluggable power elements, and
wherein said control module is configured to electronically control at least one of said pluggable power elements for each said power output line,
wherein said control module is configured to electronically control at least one of said pluggable power elements based on signals associated with said J1939 bus,
wherein each said power module is configured to provide power load shedding for associated electrical components, and
wherein, for each power output line, said control module is configured to switch automatically from a malfunctioning pluggable power element to a backup pluggable power element to supply power for the associated power output line.

2. The system of claim 1, wherein each said pluggable power element is selected from a group consisting of a fuse, a circuit breaker, a pass through element, a normally open element, a normally closed element, a step down converter, and a step up converter.

3. The system of claim 1,
wherein each said power output line has associated therewith a plurality of said pluggable power elements, and
wherein pluggable power elements of said plurality associated with a same power output line are different elements.

4. The system of claim 1, wherein pluggable power elements of said plurality associated with a same power output line have the same function.

5. The system of claim 1,
wherein the system is configured to perform diagnostics, and
wherein the performance of diagnostics includes monitoring at least one of said pluggable power elements and detecting a condition of said at least one monitored pluggable power element to diagnose a condition of the system.

6. The system of claim 5, wherein the condition of the system indicates at least one of an open, a short, and a tripped circuit breaker for power output lines associated with the at least one said monitored pluggable power element.

7. The system of claim 1,
wherein the system is configured to perform diagnostics, and
wherein the performance of diagnostics is based on information associated with at least one of said pluggable power elements.

8. The system of claim 1,
wherein the system is configured to perform prognostics, and
wherein the performance of prognostics includes monitoring at least one of said pluggable power elements, and estimating, based on the monitoring, a condition of one or more of any of said pluggable power elements and any of said electrical components.

9. The system of claim 1,
wherein the system is configured to perform prognostics, and
wherein the performance of prognostics is based on information associated with one of said pluggable power elements that is electronically controlled by said control module.

10. A method for controlling power to electrical components in a network for a vehicle, comprising:
providing a circuit board coupled to a backplane of a power module;
removably coupling a power element to a receptacle of the circuit board;
providing a controller adapted to control electronically a supply of power for at least one of the electrical components in the vehicle network;
associating the power element with the at least one electrical component of the vehicle network;
diagnosing a characteristic associated with the power element;
generating a signal in response to the diagnosing;
the controller electronically controlling a supply of power for said at least one electrical component by controlling the power element associated with the at least one electrical component based on said generating a signal in response to the diagnosing; and
reconfiguring the supply of power in response to the signal.

11. The method of claim 10, further comprising prognosticating with respect to a characteristic of the network based on said electronically controlling the power element associated with said one electrical component.

12. The method of claim 10, further comprising prognosticating with respect to a characteristic of the power element associated with said one electrical component based on said electronically controlling the power element associated with said one electrical component.

13. The method of claim 10, wherein reconfiguring the supply of power comprises a load shedding operation.

14. A reconfigurable apparatus comprising:
power controlling means for controlling power output to outside the reconfigurable apparatus;
power supplying means for supplying power to said power controlling means; and
controlling means for electronically controlling said power controlling means, said controlling means being coupled to said power controlling means,
wherein said controlling means electronically controls said power controlling means based on at least one of signals received from a bus external to the reconfigurable apparatus and signals received from said power controlling means, and
wherein said power controlling means is automatically reconfigurable in response to at least one of said signals.

15. The reconfigurable apparatus of claim 14,
wherein said power controlling means includes:
a plurality of pluggable power elements to control power output to outside the reconfigurable apparatus, each said pluggable power element being removably coupled to a configuring means for configuring the reconfigurable apparatus; and
a plurality of power output terminals, each said power output terminal being coupled to at least one of said pluggable power elements,
wherein each said pluggable power element is configured to be electronically controlled by said controlling means based on at least one of the signals received from the external bus and the signals received from said power controlling means.

16. The reconfigurable apparatus of claim 15,
wherein each said pluggable power element includes one or more pluggable power element portions, and
wherein one or more of said pluggable element portions are configured to be controlled by said controlling means based on at least one of said signals received from the external bus and said signals received from said power controlling means.

17. The reconfigurable apparatus of claim 14, further comprising load shedding means for performing a load shedding operation.

18. The reconfigurable apparatus of claim 15, further comprising diagnosing means for diagnosing a condition or a soon-to-be condition of an electronic component coupled to the reconfigurable apparatus based on a characteristic of one or more of the pluggable power elements associated with the electronic component.

19. The reconfigurable apparatus of claim 15, further comprising diagnosing means for diagnosing a condition of one or more of the pluggable power elements.

20. The reconfigurable apparatus of claim 14, further comprising redundancy means for providing power output to outside the reconfigurable apparatus.
